(19) United States
(12) Patent Application Publication
(10) Pub. No.: US 2008/0261163 A1
(43) Pub. Date: Oct. 23, 2008

(54) Duct Burner, Particularly for a Fuel Cell System

(75) Inventors: Martin Brenner, Kieselbronn (DE); Herbert Damsohn, Aichwald (DE); Thomas Heckenberger, Leinfelden-Echterdingen (DE); Klaus Luz, Herrenberg (DE); Conrad Pfender, Besigheim (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/658,864

(22) PCT Filed: Jul. 11, 2005
(86) PCT No.: PCT/EP2005/007494

§ 371 Date: Mar. 26, 2008

(30) Foreign Application Priority Data
Aug. 2, 2004 (DE) 10 2004 037 689.1

(51) Int. Cl. F23D 14/22; F23D 14/58; H01M 8/06

(52) U.S. Cl. 431/354; 429/20

(57) ABSTRACT

The invention relates to a duct burner (1), particularly for a fuel cell system (2), in which two media are brought together, mixed and combusted to generate heat. To this end, the duct burner (1) has a number of nozzles (9), which are distributed over a surface and via which the media are fed to a burn-out chamber (8). Before feeding to the nozzles (9), the first medium in a first distributing chamber (5) and the second medium in a separate second distributing chamber (7) are each distributed onto a surface that corresponds approximately to the surface (F) of the burn-out chamber (8).

The invention. relates to a surface burner, in particular for a fuel cell system, according to the preamble of claim 1.

In fuel cells, in particular in high-temperature fuel cells such as oxide ceramic fuel cells (SOFC) with operating temperatures of usually approximately 800-1000° C., it is appropriate, in order to increase the efficiency using an optimized temperature control, to combust the exhaust gas (cathode and anode exhaust gas) using a burner. If the exhaust gas is combusted, it is possible, on the one hand, to use the generated thermal energy to preheat the cold fresh air using a heat exchanger and, on the other hand, it is possible, when starting, to heat the cathode more quickly to the necessary operating temperature and maintain this temperature, which is necessary in particular in high-temperature fuel cells. In addition, combusting the exhaust gas reduces the emissions.

DE 94 15 729 U1 proposes a fuel cell block which is arranged dipping into an approximately pot-shaped housing, the housing being provided with a housing cover which has the feed ducts for fuel and oxidation means (air). Two heat exchangers (cross current heat exchangers) are provided on the housing cover and serve to heat the combustion air and the fuel using the exhaust gases generated in the interior of the pot. The fuel cell block is surrounded on all sides in its dipping region by a flow chamber which is acted on by the hot exhaust gases. In order to reach the necessary temperatures, a burner is provided in the bottom of the housing and said burner can also, if appropriate, be operated with the exhaust gas which acts on the fuel cell. A ceramic surface burner (not explained in more detail) is proposed as the burner.

The object of the invention is to make available a surface burner, in particular for a fuel cell system, which is of such compact design that a fuel cell system which is equipped with it in particular also satisfies the requirements made of mobile fuel cells.

This object is achieved by means of a surface burner having the features of claim 1. Advantageous embodiments are the subject matter of the subclaims.

The invention relates to a surface burner, in particular for a fuel cell system, in which two media are combined, mixed and combusted in order to generate heat, the surface burner having a plurality of nozzles distributed over a surface, through which the media are fed to a burn-out chamber. Here, before the feed to the nozzles, the first medium is distributed in a first distributor chamber and the second medium is distributed in a second distributor chamber, embodied separately therefrom, over in each case one surface which corresponds approximately to the surface of the burn-out chamber. The provision of two distributor chambers with a plurality of nozzles which are arranged distributed over the distributor chambers permits optimum distribution of the media and, associated therewith, optimum introduction of the media into the burn-out chamber, as a result of which in particular the burn-out chamber can be kept relatively flat.

Here, preferably a plurality of nozzles are distributed in a uniform dense fashion over the burner surface. The plurality of nozzles permits, with a short burn-out distance associated with a flat burn-out chamber, the most complete possible conversion of the combined media. Here, the burn-out distance is minimal if the mixing distance of the combined media is minimized.

The nozzles preferably have a coaxial arrangement of the feed of the two media to the burn-out chamber. The nozzles preferably have a line region with an approximately cylindrical shape for feeding the first medium into the burn-out chamber, the line region projecting into the burn-out chamber so that the second distributor chamber is bypassed, and an opening which is embodied at least in certain areas as an annular gap, for feeding the second medium into the burn-out chamber, and in which the first line region is arranged and beyond which it projects somewhat, in order to prevent the medium flowing back into the second distributor chamber from the first distributor chamber. The coaxial arrangement permits a short mixing distance so that the surface burner can be made flatter.

In order to permit optimum media distribution with an installation space which is as flat as possible, the flow cross section of the distributor chambers is made proportional to the introduced media volume flows. In this way, the overall height can be minimized and a compact, in particular flat, surface burner is obtained.

The nozzles are preferably distributed uniformly over the surface, in particular arranged in rows. The uniform distribution permits uniform combustion.

The surface in which the nozzles are arranged is preferably approximately of the same size as an adjoining heat exchanger or fuel cell stack surface, the surface preferably having an approximately rectangular shape. This permits a large heat-exchanging surface. When used with high-temperature fuel cells, this permits uniform and relatively quick heating during starting and permits uniform heating, if required, during continuous operation. The large surface permits a compact design with a relatively small overall height.

A nozzle is preferably formed by two nozzle half shells which are connected to one another. Here, the nozzle half shells can also form a plurality of nozzles arranged in a row. Such an arrangement is relatively easy and very cost-effective to manufacture using correspondingly punched-out, shaped pieces of sheet metal which are connected to one another.

The nozzles preferably have positioning and attachment elements which are formed by edges which are fitted into correspondingly embodied slit-shaped extensions of openings which are provided in a plate arranged between the second distributor chamber and the burn-out chamber. The edges preferably extend in the radial direction with respect to the longitudinal axis of the nozzle. In addition to the positioning and attachment function, the edges also have the task of connecting to one another, in their end region, the two half shells which form the nozzles, so that a gap formation, which is prevented the first medium from flowing into the second distributor chamber.

In order to ensure optimum mixture of the two media in the burn-out chamber, the nozzles have, according to one embodiment, a blind hole-like shape in the region projecting into the burn-out chamber, at least one bore being provided in this region of the nozzle projecting into the burn-out chamber. The bore preferably extends in the radial direction with respect to the longitudinal axis of the nozzle but can also be arranged at an angle thereto, which under certain circumstances improves the mixing of the two media. Two bores which are aligned with one another and can thus be manufactured in one working operation are preferably provided. Oblique flowing out improves the lateral mixing and shortens the burn-out path so that the height of the burn-out chamber can be reduced.

The nozzle preferably has an eddying device which is preferably formed by a helical swirl stamped element in the lower region of the nozzle, through which region the first medium flows shortly before emerging into the burn-out chamber. Of course, an eddying device can also be provided in the region through which the second medium arrives in the burn-out chamber.

In order to permit optimum eddying with the smallest possible drop in pressure, the upper region through which the first medium is directed is embodied with a relatively large cross section, and the eddying device is embodied with a tapered cross section in a lower region.

In order to increase the discharge speed to the burn-out chamber, the nozzles can have a tapered cross section at the end.

Such a surface burner is preferably provided on high-temperature fuel cells. As a result of the compact design, the fuel cell system is also suitable for mobile use and/or under restricted spatial conditions.

The invention is explained in detail below by means of an exemplary embodiment with variants and with reference to the drawing, in which:

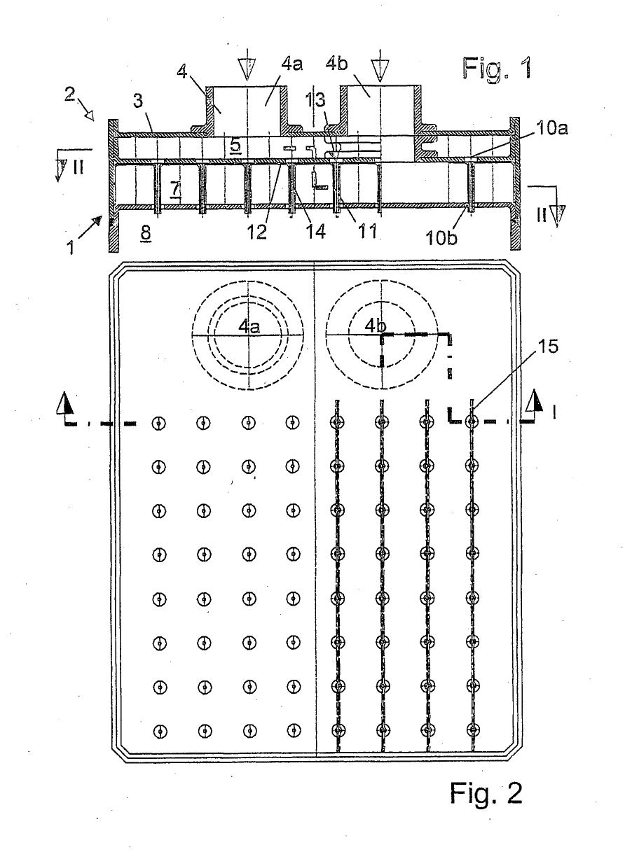

FIG. 1 shows a section through a surface burner of a fuel cell system along the line I-I in FIG. 2 according to the exemplary embodiment,

FIG. 2 shows a section along the line II-II in FIG. 1,

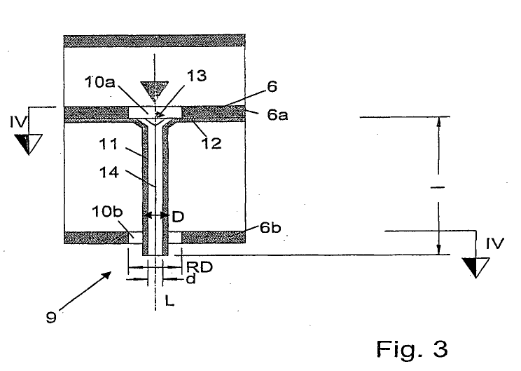

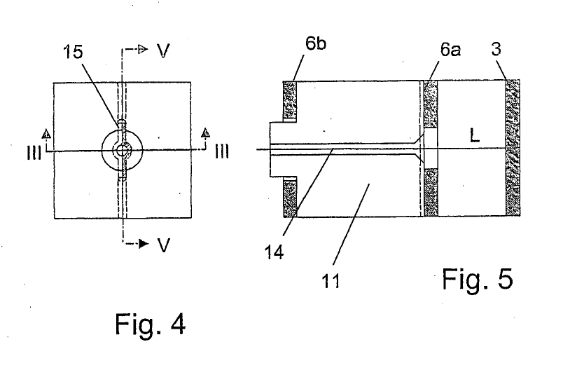

FIG. 3 is a schematic illustration of a detail of a nozzle element in longitudinal section along the line III-III in FIG. 4,

FIG. 4 shows a section along the line IV-IV in FIG. 3,

FIG. 5 shows a longitudinal section along the line V-V in FIG. 4,

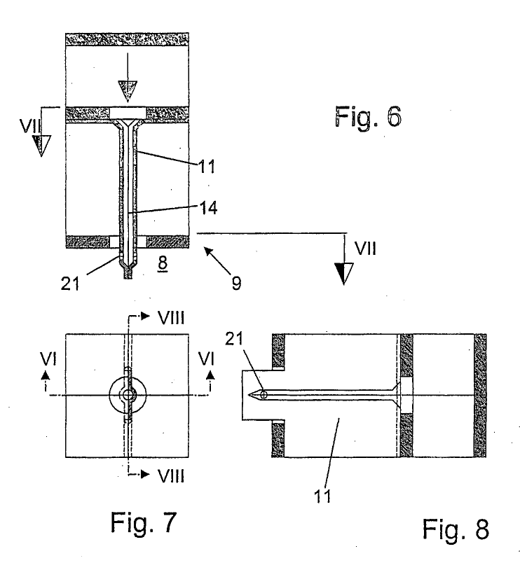

FIG. 6 is a schematic illustration of a detail of a nozzle element according to a first variant in longitudinal section along the line VI-VI in FIG. 7,

FIG. 7 shows a section along the line VII-VII in FIG. 6,

FIG. 8 shows a longitudinal section along the line VIII-VIII in FIG. 7, and

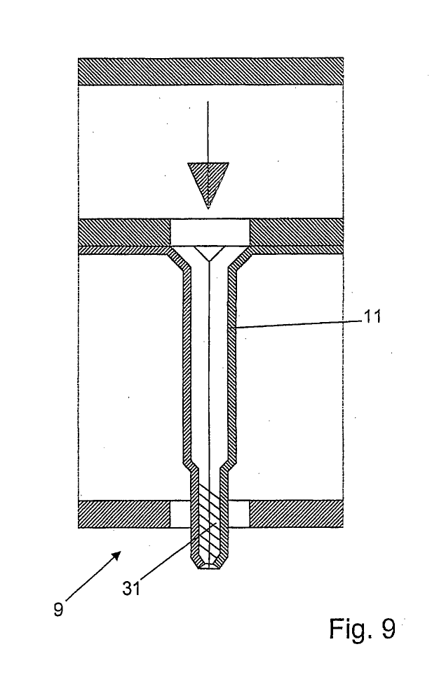

FIG. 9 is a schematic illustration of a detail of a nozzle element according to a second variant in longitudinal section.

FIG. 1 shows a section through a surface burner 1 of a fuel cell system 2 with a plurality of fuel cells (not illustrated in more detail) which are assembled in a stack design. An example of a stack design is described, for example, in DE 195 28 117 A1 with reference to a heat exchanger, the disclosure content of said document being expressly included. The fuel cell stack, here SOFC fuel cells arranged in a stack form in accordance with DE 195 28 177 A1, of the fuel cell system 2 is separated here by a cover plate 3 with two openings 4 for feeding in exhaust gas and air in order to be mixed and combusted by the surface burner 1.

The exhaust gas which is generated as a reaction product in the individual fuel cells and comes from said fuel cells via openings, partially forming part of a line owing to a corresponding plate form, and partially connected to separate lines, into individual plate elements is directed via a first inlet opening 4a into an exhaust gas distributor chamber 5 which extends in a planar fashion underneath the fuel cells. Air, which is necessary for the combustion of the exhaust gas, is directed through a second inlet opening 4b to an air distributor chamber 7 which is arranged underneath the exhaust gas distributor chamber 5 and is separated from it by a plate 6, also referred to below as first plate 6a, and the surface extent of said air distributor chamber 7 corresponds to that of the exhaust gas distributor chamber 5. Underneath the air distributor chamber 7, separated by a further plate 6, also referred to below as second plate 6b, a burn-out chamber 8 is arranged, also with a corresponding surface extent, the surface of the burn-out chamber 8 being designated by F. The base of the burn-out chamber 8 is not illustrated but it is embodied in such a way that an opening is provided for the exhaust gas which is generated during the combustion of exhaust gas and air in the burn-out chamber 8, and that in addition it is possible to clean the burn-out chamber 8.

The exhaust gas and the air are introduced into the burn-out chamber 8 by means of a plurality of nozzles 9 whose distribution over the distributor chambers 5 and 7 is illustrated in FIG. 2. The nozzles 9 are attached to openings 10a which in the plate 6 which separates the exhaust gas distributor chamber 5 and the air distributor chamber 7, the nozzles 9 being formed by two nozzle half shells 11 which have, in their upper region, an edge 12 which is bent over towards the outside through 90° with respect to the longitudinal axis L of the nozzle and which is attached in a planar fashion to the plate 6. The nozzles 9 have a funnel-shaped inlet 13 and a cylindrical line region 14 with an internal diameter d and an external diameter D. The nozzle length is designated by 1 below.

The lower end of the nozzles 9 projects through the second plate 6b which separates the air distributor chamber 7 from the burn-out chamber 8, for which reason openings 10b are provided in the second plate 6b, said openings 10b corresponding in their diameter approximately to the openings 10a in the first plate 6a, but, owing to the half shell configuration of the nozzles 9, they have slit-shaped extensions 15 so that the nozzle ends in whose region the two pieces of sheet metal which form the nozzle half shells 11 are embodied so as to be longer than in the intermediate regions between the nozzles 9, a sufficient contact surface for reliable planar connection between the two nozzle half shells 11 also being provided in their end region in the form of edges which protrude laterally in the radial direction from the cylindrical region of the nozzles 9, can be fitted through, positioned securely and attached to the second plate 6b (cf. FIGS. 4 and 5), which is done here by means of a laser weld connection, a purely mechanical attachment means or a soldered connection which is configured for the operating temperature also being possible.

The opening diameter RD in the bore region of the openings 10b is. dimensioned here as a function of the internal diameter d and the external diameter D of the cylindrical line region 14 in such a way that an optimum mixture of exhaust gas and air and thus optimum combustion in a burn-out chamber 8 which is embodied so as to be as flat as possible takes place. The same also applies to the number and distribution of the nozzles 9, the intention being to achieve optimized specific performance per unit surface area of the surface burner 1 while having the smallest possible overall height. For this purpose, the height or the flow cross section of the distributor chambers 5 and 7 is approximately proportional to the introduced volume flows.

According to the present exemplary embodiment, the following dimensions are provided:

internal diameter d: approximately 0.8 mm

external diameter D: approximately 1.4 mm

nozzle length 1: approximately 10 mm

opening diameter RD: approximately 3 mm.

According to a first variant of the exemplary embodiment which is illustrated in FIGS. 6 to 8, the nozzle ends are closed off at the bottom, but a bore 21 which passes through the two nozzle half shells 11 and extends perpendicularly to the nozzle half shells 11 and through which the exhaust gas can flow into the burn-out chamber 8 is provided in the lower region of the blind hole which forms the line region 14. Otherwise, the variant does not differ from the exemplary embodiment so that no further description is necessary. The second variant illustrated in FIG. 9 has an internal diameter and an external diameter which change over the length of the nozzle 9, the internal diameter being increased in the upper region in order to reduce the drop in pressure, and a helical swirl stamped element 31 for improving the eddying is provided in the lower region which is embodied in a tapered fashion, and the nozzle end is additionally embodied in a tapered fashion so that the flowing-out speed of the exhaust gas is increased.

The designation exhaust gas has been used above because the exemplary embodiment and its variants refer to a fuel cell system in which the exhaust gas is used for combustion. However, it goes without saying that instead of exhaust gas it is also possible to use a combustion gas which is fed from the outside in order to operate the surface burner, or such a combustion gas can be added to the exhaust gas.

### LIST OF REFERENCE SYMBOLS

1 Surface burner
2 Fuel cell system
3 Cover plate
4 Opening
4a First inlet opening (exhaust gas)
4b Second inlet opening (air)
5 Exhaust gas distributor chamber
6 Plate
6a First plate
6b Second plate
7 Air distributor chamber
8 Burn-out chamber
9 Nozzle
10a, 10b Opening
11 Nozzle half shell
12 Edge
13 Funnel-shaped inlet
14 Line region
15 Slit-shaped extension
21 Bore
31 Helical swirl stamped element
D External diameter
d Internal diameter
F Surface
L Longitudinal axis of the nozzle
1 Nozzle length
RD Opening diameter

1. A surface burner, in particular for a fuel cell system, in which two media are combined, mixed and combusted in order to generate heat, the surface burner having at least one nozzle through which the media are fed to a burn-out chamber, wherein a plurality of nozzles are provided distributed over a surface, the first medium being distributed in a first distributor chamber and the second medium being distributed in a second distributor chamber, embodied separately therefrom, before the feed to the nozzles, over in each case one surface which corresponds approximately to the surface of the burn-out chamber.

2. The surface burner as claimed in claim 1, wherein the flow cross section of the distributor chambers is proportional to the introduced media volume flows.

3. The surface burner as claimed in claim 1, wherein the nozzles are embodied in such a way that a medium is directed through the second distributor chamber using some of the nozzles.

4. The surface burner as claimed in claim 1, wherein the nozzles have a coaxial arrangement of the feed of the two media to the burn-out chamber.

5. The surface burner as claimed in claim 1, wherein the nozzles a line region with an approximately cylindrical shape for feeding the first medium into the burn-out chamber, the line region projecting into the burn-out chamber, and an opening which is embodied at least in certain areas as an annular gap and in which the first line region is arranged, for feeding the second medium into the burn-out chamber.

6. The surface burner as claimed in claim 1, wherein the nozzles are distributed uniformly over the surface.

7. The surface burner as claimed in claim 1, wherein the nozzles are arranged distributed in rows over the surface.

8. The surface burner as claimed in claim 1, wherein the surface in which the nozzles are arranged is approximately of the same size as an adjoining heat exchanger or fuel cell stack surface.

9. The surface burner as claimed in claim 1, wherein the surface has a rectangular outline.

10. The surface burner as claimed in claim 1, wherein a nozzle is formed by two nozzle half shells which are connected to one another.

11. The surface burner as claimed in claim 10, wherein two nozzle half shells form a plurality of nozzles arranged in a row.

12. The surface burner as claimed in claim 10, wherein the nozzle half shells are formed by punched-out and shaped pieces of sheet metal.

13. The surface burner as claimed in claim 1, wherein the nozzles have positioning and attachment elements which are formed by edges which are fitted into correspondingly embodied slit-shaped extensions of openings which are provided in a plate arranged between the second distributor chamber and the burn-out chamber.

14. The surface burner as claimed in claim 13, wherein the edges extend in the radial direction with respect to the longitudinal axis of the nozzle.

15. The surface burner as claimed in claim 1, wherein the nozzles are embodied in the manner of a blind hole in the region projecting into the burn-out chamber, at least one bore being provided in the nozzle.

16. The surface burner as claimed in claim 15, wherein the bore extends in the radial direction with respect to the longitudinal axis of the nozzle.

17. The surface burner as claimed in claim 1, wherein the nozzle has an eddying device.

18. The surface burner as claimed in claim 17, wherein the eddying device is formed by a helical swirl stamped element.

19. The surface burner as claimed in claim 17, wherein the eddying device is embodied with a tapered cross section in one region.

20. The surface burner as claimed in claim 1, wherein the nozzles have a tapered cross section at the end.

21. A fuel cell system, comprising at least one high-temperature fuel cell, and a surface burner as claimed in claim 1.
